(19) United States
(12) Patent Application Publication
(10) Pub. No.: US 2015/0025164 A1
(43) Pub. Date: Jan. 22, 2015

(54) POLYURETHANE RIGID FOAMS

(71) Applicants: Paolo Golini, Reggio Emilia (IT); Maurizio Guandalini, Bagnolo In Piano (IT)

(72) Inventors: Paolo Golini, Reggio Emilia (IT); Maurizio Guandalini, Bagnolo In Piano (IT)

(73) Assignee: Dow Global Technologies LLC, Midland, MI (US)

(21) Appl. No.: 14/241,650

(22) PCT Filed: Aug. 24, 2012
(86) PCT No.: PCT/EP2012/066478

§ 371 Date: Feb. 27, 2014

(30) Foreign Application Priority Data
Sep. 2, 2011 (IT) MI2011A001574

(51) Int. Cl. C08G 18/42; C08K 5/521; C08G 18/76; C08G 18/08; C08G 18/48

(52) U.S. Cl. CPC C08G 18/4244; C08G 18/14; C08G 18/4833; C08G 18/7664; C08K 5/521; C08G 2101/0025
USPC 521/107; 521/173; 528/76

(57) ABSTRACT

The present invention relates to polyurethane rigid foams formulations. More particularly, the present invention relates to polyurethane rigid foams formulations, prepared from aromatic polyester polyols, which show improved compressive strength. The formulations include an isocyanate reacting mixture, at least one polymeric diphenylmethane diisocyanate, having a functionality of at least 2.7, and at least one blowing agent; such that the stoichiometric index of the polyisocyanate to the isocyanate reacting mixture is 1.0-1.8.

The present invention relates to polyurethane rigid foams. More particularly, the present invention relates to polyurethane rigid foams, prepared from aromatic polyester polyols, which show improved compressive strength.

Polyurethane rigid foams are widely used as insulating materials in the construction industry. Typically these foams are closed-cell, rigid foams containing within the cells a low-conductivity gas, such as a hydrocarbon (HC). The foaming compositions, being liquid, may be used in pour-in-place applications, sprayed applications and to form rigid foam boards or panels. The panels, which may be produced via continuous or discontinuous process technology, may include a facing, such as a metal foil, to which the foam adheres. These panels may be referred to as sandwich panels.

Unfortunately, these foams may suffer from drawbacks in that the requirement of lower and lower densities makes the insulated panels exposed to higher risk of not matching physico-mechanical properties such as, for instance, compressive strength, and/or cause the panels to be unsuitable to match aesthetic performance durability in end-use.

The use of fillers, such as—for instance—glass microspheres, and/or of specific catalysts is known in the art in order to improve compressive strength.

CN 1995088 discloses heat-resistant rigid polyurethane foams and manufacturing methods therefor wherein foams are prepared from polyether polyols having functionality of 5-6 or optionally containing heterocyclic structures, aromatic ring-containing polyester polyols, polymethylene polyphenyl isocyanate (PAPI, having an isocyanate index equal to 1), catalysts, blowing agents, and foam stabilizers. Foams are for instance prepared from ethylene oxide-propylene oxide copolymer sorbitol ether, diethylene glycol-phthalic anhydride copolymer, PAPI and additives. JP 10182784 discloses manufacturing polyurethane rigid foams showing improved fluidity, heat insulation, mold realize and low-temperature dimensional stability by mixing and reacting (A) an organic polyisocyanate, such as toluene diisocyanate or diphenylmethane diisocyanate, with a resin premix composed of (B) a polyol component consisting of (i) a polyether polyol having 60-100 mol % sucrose concentration in an initiator, 6.0-8.0 average functionality and 280-600 mg KOH/g hydroxyl value, in an amount of 5-50 parts by weight (pbw) based on 100 pbw of the polyol component and (ii) an aromatic polyol having 2.0-2.9 average functionality and 280-600 mg KOH/g hydroxyl value, in an amount of at least 20 pbw based on 100 pbw of the polyol component; (C) 1,1-dichloro-1-fluoroethane as a foaming agent; (D) a catalyst; (E) a foam stabilizer and (F) other auxiliaries.

U.S. Pat. No. 6,071,978 discloses a process for preparing polyurethane rigid foams, showing low thermal conductivities, from polyols and polyisocyanates as well as blowing agents and optionally foam auxiliary agents, characterized in that the polyurethane rigid foam is obtained by reacting (A) a polyol component with an average at least 3 hydrogen atoms, containing (i) 60-100% of polyethers and/or polyesters with at least 2 hydroxyl groups and a molecular weight of 250-1,500, having a surface tension of 6-14 mN/m with respect to i-pentane and/or n-pentane as blowing agent, wherein the polyethers are obtained by the polyaddition of 70-100 wt. % of ethylene oxide and 0-30 wt. % of propylene oxide to starter compounds (ii) i-pentane and/or n-pentane as blowing agent, (iii) water and (iv) optionally auxiliary agents and additives; with (B) a polyisocyanate with an NCO-content of 20-48 wt. % which has a surface tension of 4-8 mN/m with respect to i-pentane or n-pentane as blowing agent.

JP 2000063475, JP 2000063476 and JP 2000063477 disclose a process for obtaining rigid polyurethane foams, which have improved adiabatic properties and suffer no crack within a low or ultra-low temperature range, by employing a specific aliphatic polyester polyol (preferably a combination of a sucrose-based polyol containing as an essential ingredient a sucrose in an initiator and having an average functionality of 3-7 and a hydroxyl value of 300-500 mg KOH/g with an aromatic polyol having an average functionality of 2-4 and a hydroxyl value of 280-500 mg KOH/g) in a peculiar amount, using preferably cyclopentane, 1-chloro-1,1-difluoroethane, 1-chloro-1,1-difluoromethane, 1,1,1,2-tetrafluoroethane, 1,1,1,3,3-pentafluoropropane, as a blowing agent.

JP 10212334 describes a method for obtaining a composition which can give a foam reported to show improved resistance to low-temperature, wet-heat, high-temperature dimensional stability, compressive strength, heat conductivity, etc., by using an organic polyisocyanate component comprising a low-viscosity polyphenylmethane polyisocyanate (A) being an NCO-terminated prepolymer having a viscosity of 100-250 mPa·s/25° C. and an NCO content of 29.5-32.5 wt. %, and obtained by reacting an isocyanate with a polyol under NCO-excess conditions, and a high-viscosity polyphenylmethane polyisocyanate (B) having a viscosity of 400-700 mPa·s/25° C. and an NCO content of 28.5-32.0 wt. %, in a (b)/(a) ratio of 0.3-11.0, a polyether polyol and/or a polyester polyol (C) each having a number average molecular weight of 400-6,000 and a functionality of 2-6, (D) a blowing agent being a hydrocarbon compound, (E) a catalyst, (F) a foam stabilizer, and (G) other additives.

WO 02/40566 discloses a method of preparing a polyurethane-modified rigid foam, comprising reacting an active hydrogen compound having at least two functionalities with a polyisocyanate compound in the presence of a catalyst and a blowing agent comprising water alone or a mixture of water and a low boiling compound, wherein: (i) the polyisocyanate compound is a prepolymer obtained by reacting a polymeric MDI with 5 to 30% by weight, based on the polymeric MDI, of a polyether polyol and/or polyester polyol having a hydroxy value of at most 100 mg KOH/g, and (2) the number of isocyanate groups in the polyisocyanate compound is at least 1.5 times by mole as large as the number of active hydrogen atoms in the active hydrogen compound and water. The resulting rigid foam is reported to have improved dimensional stability, adhesion and compressive strength.

Yet, according to the applicant's experience, these prior art foams still do not allow to produce products, such as—for instance—insulated panels, showing suitable physico-mechanical properties (compressive strength and the like), and/or suitable to match aesthetic performance durability in end-use.

Accordingly, the need to have polyurethane rigid foams which could allow to prepare products, such as—for instance—insulated panels, matching the above mentioned properties and characteristics, yet avoiding catalysis modification which could negatively impact reaction parameters, as well as avoiding using either fillers or any other substance not easily handy from a process perspective, and limiting raising of the cost due to an extremely likely specific raw material gap versus demand, in the very next future, is strongly felt in the field.

Surprisingly, the applicant found that the above technical problem could be advantageously solved by peculiar polyurethane rigid foams, prepared from aromatic polyester polyols, showing improved compressive strength and processability.

According to a first aspect, the present invention does indeed relate to a polyurethane foam formulation comprising:

(A) an isocyanate reacting mixture comprising:
(i) 10-40% by weight of at least one aromatic polyester polyol having a hydroxyl number of at least 50 mg KOH/g and a functionality greater than 2;
(ii) 30-75% by weight of at least one propoxylated sucrose- and/or propoxylated sorbitol-initiated polyol, having a molecular weight of 200-1,500, a hydroxyl number of at least 150 mg KOH/g and a functionality of at least 4;
(iii) 5-25% by weight of at least one polyether polyol based on propylene glycol moiety, having a hydroxyl value of 50-600 mg KOH/g;
   all percentages in (i), (ii) and (iii) being based on the overall weight of the isocyanate reacting mixture;

(B) at least one polymeric diphenylmethane diisocyanate (PMDI) having a functionality of at least 2.7; and

(C) at least one blowing agent;

such that the stoichiometric index of the polyisocyanate to the isocyanate reacting mixture is 1.0-1.8.

The aromatic polyester polyol is preferably selected from aromatic polyester polyols having an acid component comprising at least 30% by weight of phthalic acid residues, or residues of isomers thereof; also, the aromatic polyester polyol has an aromatic ring content of at least 50% by weight, based on the aromatic polyester polyol weight, and it is preferably obtained by the transesterification of crude reaction residues or scrap polyester resins.

Besides, the aromatic polyester polyol has preferably a hydroxyl number of 50-400, more preferably 150-300, mg KOH/g whereas its functionality is preferably higher than 2 up to 8.

According to further preferred embodiments, the propoxylated sucrose- and/or propoxylated sorbitol-initiated polyol have a molecular weight of 450-900, a functionality of 4-8 and a hydroxyl number of 300-550 mg KOH/g; also, the propoxylated sucrose- and/or propoxylated sorbitol-initiated polyol may be water co-initiated and may be contained in a water co-initiated sorbitol and/or sucrose based polyols.

The polyether polyol is preferably in an amount of 8-20% by weight with respect to the overall weight of the isocyanate reacting mixture and has a hydroxyl value of 100-300 mg KOH/g; most preferred polyether polyols are Voranol™ 1010L and Voranol™ P-400.

The blowing agent may be preferably selected from the group consisting of at least one among butane, isobutane, 2,3-dimethylbutane, n- and i-pentane isomers, hexane isomers, heptane isomers, cycloalkanes including cyclopentane, cyclohexane, cycloheptane, HFC-245fa (1,1,1,3,3-pentafluoropropane), HFC-365mfc (1,1,1,3,3-penta-fluorobutane), HFC-227ea (1,1,1,2,3,3,3-heptafluoropropane), HFC-134a (1,1,1,2-tetrafluoroethane), formic acid, isobutyric acid, ethylbutyric acid, ethylhexanoic acid, water and carbamates.

The polymeric diphenylmethane diisocyanate has preferably a functionality of 2.7-2.9, an equivalent weight of 130-140 and a viscosity of 0.2-0.7 Pa·s at 25° C.

According to another preferred embodiment, the polyurethane foam formulation according to the invention may comprise water, at least one surfactant, at least one crosslinker, at least one catalyst and at least one flame retardant. Particularly, the polyurethane foam formulation according to the invention preferably comprises water, the surfactant, crosslinker, catalyst and flame retardant in an overall amount of 6-12 pbw whereas (A), (B) and (C) are in an amount of 25-35 pbw, 50-65 pbw, 2-5 pbw, respectively.

According to another embodiment, the present invention also relates to an isocyanate reacting mixture comprising:

(i) 10-40% by weight of at least one aromatic polyester polyol having a hydroxyl number of at least 50 mg KOH/g and a functionality greater than 2;

(ii) 30-75% by weight of at least one propoxylated sucrose- and/or propoxylated sorbitol-initiated polyol, having a molecular weight of 200-1,500, a hydroxyl number of at least 150 mg KOH/g and a functionality of at least 4;

(iii) 5-25% by weight of at least one polyether polyol based on propylene glycol moiety, having a hydroxyl value of 50-600 mg KOH/g;

all percentages in (i), (ii) and (iii) being based on the overall weight of the isocyanate reacting mixture.

Still another embodiment of the invention concerns a process for preparing a polyurethane foam comprising contacting, under foam-forming conditions, (A) an isocyanate reacting mixture comprising: (i) 10-40% by weight of at least one aromatic polyester polyol having a hydroxyl number of at least 50 mg KOH/g and a functionality greater than 2; (ii) 30-75% by weight of at least one propoxylated sucrose- and/or propoxylated sorbitol-initiated polyol, having a molecular weight of 200-1,500, a hydroxyl number of at least 150 mg KOH/g and a functionality of at least 4; (iii) 5-25% by weight of at least one polyether polyol based on propylene glycol moiety, having a hydroxyl value of 50-600 mg KOH/g; all percentages in (i), (ii) and (iii) being based on the overall weight of the isocyanate reacting mixture; (B) at least one polymeric diphenylmethane diisocyanate (PMDI) having a functionality of at least 2.7; and (C) at least one blowing agent; such that the stoichiometric index of the polyisocyanate to the isocyanate reacting mixture is 1.0-1.8; to form a polyurethane rigid foam.

The process for preparing a polyurethane foam according to the present invention is preferably carried out by contacting the isocyanate reacting mixture, polyisocyanate and blowing agent as two streams, three streams, or more than three streams; also preferred is spraying or depositing onto a substrate the mixed streams. This substrate may be, for example, a rigid or flexible facing sheet made of foil or another material, including another layer of similar or dissimilar polyurethane which is being conveyed, continuously or discontinuously, along a production line, or directly onto a conveyor belt. Most preferably, a sandwich panel is formed.

The polyurethane foam, formed by the process for preparing a polyurethane foam according to the present invention, is preferably a layer and/or the whole insulation core in a sandwich panel and may further comprise at least one rigid facing sheet, at least one flexible facing sheet, at least one layer of similar or dissimilar polyurethane or a combination thereof.

It has been found that the polyurethane foam formulation according to the present invention allows producing rigid polyurethane blown foams suitable—according to a preferred embodiment—for the insulation of sandwich panels, for instance produced by continuous process.

The polyurethane foam formulation according to the invention allows getting higher compressive strength performances which would permit rigid faced double belt lamination (RF-DBL) manufacturers to produce panels at relatively low density, still matching their quality specifications, providing a competitive alternative and advantage in not-fire rated continuous panel market.

As used herein, “aromatic” in “aromatic polyester polyol”, refers to organic compounds having at least one conjugated ring of alternate single and double bonds, which imparts an overall stability to the compounds. The term “polyester polyol” as used herein includes any minor amounts of unreacted polyol remaining after the preparation of the polyester polyol and/or unesterified polyol (for example, glycol) added after the preparation of the polyester polyol. While the aromatic polyester polyol may be prepared from substantially pure reactant materials, more complex starting materials, such as polyethylene terephthalate, may be advantageous. Other residues are dimethyl terephthalate (DMT) process residues, which are waste or scrap residues from the manufacture of DMT.

The aromatic polyester polyol may optionally contain, for example, halogen atoms and/or may be unsaturated, and may generally be prepared from the same selection of starting materials as described hereinabove, but at least one of the polyol or the polycarboxylic acid, preferably the acid, is an aromatic compound having an aromatic ring content (expressed as weight percent of groups containing at least one aromatic ring per molecule) that is at least 50% by weight, based on the total compound weight, and preferably greater than 50% by weight, i.e., it is predominantly aromatic in nature. Polyester polyols having an acid component that advantageously comprises at least 30% by weight of phthalic acid residues, or residues of isomers thereof, are particularly useful. Preferably the aromatic ring content of the aromatic polyester polyol is from 70 to 90% by weight, based on the total compound weight. Preferred aromatic polyester polyols are the crude polyester polyols obtained by the transesterification of crude reaction residues or scrap polyester resins.

The aromatic polyester polyol is also characterized in that it has a hydroxyl number of at least 50 mg KOH/g and a functionality greater than 2. In preferred embodiments, the hydroxyl number is 50-400 mg KOH/g, more preferably 150-300 mg KOH/g and functionality greater than 2 and up to 8.

The propoxylated sucrose- and/or propoxylated sorbitol-initiated polyol suitable for the present invention is a polyether polyol, having a molecular weight of 200-1,500, a functionality of at least 4 and a hydroxyl number of at least 150 mg KOH/g. Preferably, the sucrose- or sorbitol-initiated polyol has a molecular weight of 450-900, a functionality of 4-8 and a hydroxyl number of 300-550 mg KOH/g. Sucrose may be obtained from sugar cane or sugar beets, honey, sorghum, sugar maple, fruit, and the like. Means of extraction, separation, and preparation of the sucrose component vary depending upon the source, but are widely known and practiced on a commercial scale by those skilled in the art.

Sorbitol may be obtained via the hydrogenation of D-glucose over a suitable hydrogenation catalyst. Fixed beds and similar types of equipment are especially useful for this reaction. Suitable catalysts may include, for example, Raney™ (Grace-Davison) catalysts, such as employed in Wen, Jian-Ping, et. al., “Preparation of sorbitol from D-glucose hydrogenation in gas-liquid-solid three-phase flow airlift loop reactor,” The Journal of Chemical Technology and Biotechnology, vol. 4, pp. 403-406 (Wiley Interscience, 2004), incorporated herein by reference in its entirety. Nickel-aluminum and ruthenium-carbon catalysts are just two of the many possible catalysts.

In an alternative embodiment, preparation of sorbitol may begin with a starch hydrolysate which has been hydrogenated. The starch is a natural material derived from corn, wheat and other starch-producing plants. To form the hydrolysate, the starch polymer molecule may be broken into smaller oligomers at the ether bond between glucose rings, to produce glucose, maltose and higher molecular weight oligo- and poly-saccharides. The resulting molecules, having hemiacetal glucose rings as end units, may then be hydrogenated to form sorbitol, maltitol and hydrogenated oligo- and poly-saccharides. Hydrogenated starch hydrolysates are commercially available and inexpensive, often in the form of syrups, and provide the added benefit of being a renewable resource. This method may further require a separation of either the glucose, prior to hydrogenation, or of the sorbitol after hydrogenation, in order to prepare a suitable sorbitol-initiated polyol therefrom. In general, the hydrogenation reduces or eliminates the end units' tendency to form the hydroxyaldehyde form of glucose. Therefore, fewer side reactions of the sorbitol, such as Aldol condensation and Cannizzaro reactions may be encountered. Furthermore, the final polyol will comprise reduced amounts of by-products.

The sucrose- or sorbitol-initiated polyol may be made by polymerizing alkylene oxides onto the specified initiator in the presence of a suitable catalyst. In one embodiment, each of the initiators may be individually alkoxylated in separate reactions and the resulting polyols blended to achieve the desired component of the isocyanate reacting mixture. In another embodiment, the initiators may be mixed together prior to alkoxylation, thereby serving as co-initiators, prior to preparing the polyol component having a target hydroxyl number and functionality.

The polyether polyol suitable for the present invention is a polyether polyol based on propylene glycol moiety, having a hydroxyl value of 50-600 mg KOH/g. Preferred polyether polyols are: Voranol™ 1010L (OH value: 112) and Voranol™ P400 (OH value: 280). The amount of the polyether polyol comprised in the isocyanate reacting mixture above defined is 5-25% by weight, preferably 8-20%, percentages being expressed on the overall weight of the isocyanate reacting mixture.

The blowing agent(s) suitable for the present invention may be selected based in part upon the desired density of the final foam. In certain non-limiting embodiments hydrocarbon blowing agents may be selected. For example, hydrocarbon or fluorine-containing hydrohalocarbon blowing agents may be used, and in some instances may serve to reduce, or further reduce, viscosity, and thereby to enhance sprayability. Among these are, for example, butane, isobutane, 2,3-dimethylbutane, n- and i-pentane isomers, hexane isomers, heptane isomers, cycloalkanes including cyclopentane, cyclohexane, cycloheptane, and combinations thereof, HFC-245fa (1,1,1,3,3-pentafluoropropane), HFC-365mfc (1,1,1,3,3-penta-fluorobutane), HFC-227ea (1,1,1,2,3,3,3-heptafluoropropane), HFC-134a (1,1,1,2-tetrafluoroethane), combinations of two or more of the above, and the like. These hydrocarbons and/or non-fluorine-containing hydrohalocarbons are preferably used in an amount such that the total blowing agent, including the hydrofluorocarbon, is no more than 15 parts, more desirably no more than 12 parts, based on 100 parts of the total fully formulated polyol composition.

An optional chemical blowing agent that may be selected is formic acid or another carboxylic acid. Formic acid may be used in an amount of from 0.5 to 8 parts per 100 pbw of the polyol composition. In certain non-limiting embodiments, the formic acid is present in an amount from 0.5 parts and more preferably from 1 part, up to 6 parts and more preferably to 3.5 pbw. While formic acid is the carboxylic acid of preference, it is also contemplated that minor amounts of other aliphatic mono- and polycarboxylic acids may be employed, such as those disclosed in U.S. Pat. No. 5,143,945, which is incorporated herein by reference in its entirety, and including isobutyric acid, ethylbutyric acid, ethylhexanoic acid, and combinations thereof.

In addition to, or alternatively to, the formic acid or other carboxylic acid blowing agent, water may also be optionally selected as a chemical blowing agent. The water is, in some non-limiting embodiments, present in an amount of from 0.5 to 10 parts, and preferably from 1 to 6 parts, per 100 pbw of the isocyanate reacting mixture. When preparing a polyurethane foam, in order to facilitate and give desirable processing characteristics, it is advantageous not to exceed 4 parts of water, preferably not more than 3.0 parts of water, and more preferably not more than 2.0 parts of water, per 100 parts of polyol composition. Omission of water is desirable in some non-limiting embodiments.

Finally, carbamates, which release carbon dioxide during the foaming process, and their adducts may also be used advantageously as an optional, additional chemical blowing agent. Such are discussed in greater detail in, for example, U.S. Pat. Nos. 5,789,451 and 6,316,662, and EP 1 097 954, which are incorporated herein by reference in their entireties.

The polyisocyanate component suitable for the polyurethane foam formulation of the present invention comprises at least one polymeric diphenylmethane diisocyanate (PMDI) having a functionality of at least 2.7, preferably 2.7-2.9.

As an example, polyisocyanates based on 4,4′-2,4′- and/or 2,2′-diphenylmethane diisocyanate and the corresponding isomeric mixtures can be mentioned.

The PMDI preferably shows an equivalent weight between 125 and 175, more preferably from 130 to 140, and an average functionality of at least 2.7. The viscosity of the polyisocyanate component is preferably from 0.1 to 1.5 Pa·s, but values from 0.2 to 0.7 Pa·s at 25° C. are preferred.

The three minimum required components of the isocyanate reacting mixture are, in certain non-limiting embodiments, present in specific proportion ranges. While the aromatic polyester polyol may range from 10 to 40% by weight, based on the weight of the isocyanate reacting mixture as a whole, the polyether polyol based on propylene glycol moiety may range from 5 to 25% by weight, such as for example from 8 to 20% by weight. It is desirable in some embodiments that the aromatic polyester polyol be limited to a range from 10 to 25% by weight. The sucrose- or sorbitol-initiated polyol may be present in an amount ranging from 30 to 75% by weight, on the same basis. Combinations of more than one of each type of polyol (i.e.: two sorbitol initiated) may also be selected, provided their combined percentages in the formulated polyol as a whole comply with the stated ranges.

Other components may be preferably present in the polyurethane foam formulation of the present invention; for instance, other polyols may also be included in the isocyanate reacting mixture and/or in the final formulation and, if included, are considered to be part of the formulation's B-component. While these additional materials are typically included as part of the B-component during the formulating process, such are treated here separately because they are considered to be optional.

Such may include one or more other polyether or polyester polyols of the kind typically employed in processes to make polyurethane and/or foams. Other compounds having at least two isocyanate-reactive hydrogen atoms may also be present, for example, polythioether polyols, polyester amides and polyacetals containing hydroxyl groups, aliphatic polycarbonates containing hydroxyl groups, amine terminated polyoxyalkylene polyethers, and preferably, polyester polyols, polyoxyalkylene polyether polyols, and graft dispersion polyols. Mixtures of two or more of the aforesaid materials may also be employed. In many embodiments such polyols have from 2 to 8 hydroxyl groups per molecule, a molar average functionality of at least 3 or more, and a hydroxyl number of greater than 100 mg KOH/g, and in certain embodiments, greater than 300 mg KOH/g.

In some non-limiting embodiments, the isocyanate reacting mixture may also include one or more chain extenders and/or crosslinkers. Where selected, chain extenders may be bifunctional, low molecular weight alcohols, in particular those having a molecular weight of up to 400, for example ethylene glycol, propylene glycol, butanediol, hexanediol, and mixtures thereof. Crosslinkers, in many embodiments, are at least trifunctional, and may be selected from, for example, low molecular weight alcohols such as glycerol, trimethylolpropane, pentaerythritol, sucrose, sorbitol, or mixtures thereof.

The formulation of the present invention may include further additives or modifiers such as are well-known in the art. For example, surfactants, catalysts, flame retardants may be employed. Of particular significance are one or more trimerization catalysts. The trimerization catalyst employed may be any known to those skilled in the art that will catalyze the trimerization of an organic isocyanate compound to form the isocyanurate moiety. For typical isocyanate trimerization catalysts, see The Journal of Cellular Plastics, November/December 1975, page 329: and U.S. Pat. Nos. 3,745,133; 3,896,052; 3,899,443; 3,903,018; 3,954,684 and 4,101,465; the disclosures of which are incorporated by reference herein in their entireties. Typical trimerization catalysts include the glycine salts, tertiary amine trimerization catalysts, alkali metal carboxylic acid salts, and mixtures of these classes of catalysts. Preferred species within the classes are sodium N-2-hydroxy-5-nonylphenyl-methyl-N-methylglycinate, N,N-dimethylcyclohexyl-amine, and mixtures thereof. Also included in the preferred catalyst components are the epoxides disclosed in U.S. Pat. No. 3,745,133, the disclosure of which is incorporated herein by reference in its entirety.

Another category of catalysts that may be included is the amine catalysts, including any organic compound which contains at least one tertiary nitrogen atom and is capable of catalyzing the hydroxyl/isocyanate reaction between the (A) component and (B) component. Typical classes of amines include the N-alkylmorpholines, N-alkyl-alkanolamines, N,N-dialkylcyclohexylamines, and alkylamines where the alkyl groups are methyl, ethyl, propyl, butyl and isomeric forms thereof, and heterocyclic amines. Typical but non-limiting thereof are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethyl-morpholine, 2-methylpropanediamine, methyltriethylenediamine, 2,4,6-tridimethylamino-methyl)phenol, N,N′,N″-tris(dimethylamino-propyl)sym-hexahydrotriazine, and mixtures thereof. A preferred group of tertiary amines from which selection may be made comprises bis(2-dimethylamino-ethyl)ether, dimethylcyclohexylamine, N,N-dimethyl-ethanolamine, triethylenediamine, triethylamine, 2,4,6-tri(dimethylaminomethyl)phenol, N,N′,N-ethylmorpholine, and mixtures thereof.

Non-amine catalyst may also be used in the present invention. Typical of such catalysts are organometallic compounds of bismuth, lead, tin, titanium, iron, antimony, uranium, cadmium, cobalt, thorium, aluminum, mercury, zinc, nickel, cerium, molybdenum, vanadium, copper, manganese, zirconium, and combinations thereof. Included for illustrative purposes only are bismuth nitrate, lead 2-ethylhexoate, lead benzoate, lead naphthenate, ferric chloride, antimony trichloride, antimony glycolate, combinations thereof, and the like. A preferred class includes the stannous salts of carboxylic acids, such as stannous acetate, stannous octoate, stannous 2-ethylhexoate, 1-methylimidazole, and stannous laurate, as well as the dialkyl tin salts of carboxylic acids, such as dibutyl tin diacetate, dibutyl tin dilaurate, dibutyl tin dimaleate, dioctyl tin diacetate, combinations thereof, and the like. Catalysts, such as NIAX™ A-1, POLYCAT™ 9 and/or POLYCAT™ 77, may be included in amounts from 1 to 8 parts, total, of B-component. (NIAX™ A-1 is available from General Electric. POLYCAT™ 9 and POLYCAT™ 77 are available from Air Products.) Additional catalysts, such as TOYOCAT™ DM 70 or other gelling catalysts, may be included in amounts ranging from 0 to 2 parts. (TOYOCAT™ DM 70 is available from Tosoh Corporation.)

Besides, in some preferred embodiments it may be desirable to enhance also fire performance by including, as additives, one or more brominated or non-brominated flame retardants, such as tris(2-chloroethyl)phosphate, tris(2-chloro-propyl)phosphate, tris(1,3-dichloropropyl)phosphate, diammonium phosphate, various halogenated aromatic compounds, antimony oxide, alumina trihydrate, polyvinyl chloride, and combinations thereof. Dispersing agents, cell stabilizers, and surfactants may also be incorporated into the formulations.

Surfactants, including organic surfactants and silicone based surfactants, may be added to serve as cell stabilizers. Some representative materials are sold under the designations SF1109, L520, L521 and DC193, which are, generally, polysiloxane polyoxylalkylene block copolymers, such as those disclosed in U.S. Pat. Nos. 2,834,748; 2,917,480; and 2,846,458, the disclosures of which are incorporated herein by reference in their entireties. Also included are organic surfactants containing polyoxyethylene-polyoxybutylene block copolymers, as are described in U.S. Pat. No. 5,600,019, the disclosure of which is incorporated herein by reference in its entirety. It is particularly desirable to employ a minor amount of a surfactant to stabilize the foaming reaction mixture until it cures. Other surfactants include polyethylene glycol ethers of long-chain alcohols, tertiary amine or alkanolamine salts of long-chain allyl acid sulfate esters, alkylsulfonic esters, alkyl arylsulfonic acids, and combinations thereof.

Such surfactants are employed in amounts sufficient to stabilize the foaming reaction against collapse and the formation of large uneven cells. Typically, from 0.2 to 3 parts of the surfactant per 100 pbw of the isocyanate reacting mixture are sufficient for this purpose. Surfactants, such as NIAX™ L-6900 or DABCO™ DC5598, may be included in any amount ranging from 0 to 6 parts. (NIAX™ L-6900 is available from Momentive, DABCO™ DC5598 is available from Air Products).

The polyurethane polymer prepared according to the process of this invention is a rigid, foamed, closed-cell polymer. Such a polymer is typically prepared by intimately mixing the reaction components, i.e., a polyol/blowing agent component (consisting essentially of, or comprising, the isocyanate reacting mixture and blowing agent defined hereinabove), along with an isocyanate component, i.e., at least two streams; or a polyol component (consisting essentially of, or comprising, the isocyanate reacting mixture defined hereinabove), a blowing agent component, and an isocyanate component, i.e., at least three streams, wherein the isocyanate reacting mixture and blowing agent component mix just prior to contact thereof with the isocyanate component) at room temperature or at a slightly elevated temperature for a short period. Additional streams may be included, as desired, for the introduction of various catalysts and other additives. Mixing of streams may be carried out either in a spray apparatus, a mixhead with or without a static mixer for combining the polyol component and blowing agent, or a vessel, and then spraying or otherwise depositing the reacting mixture onto a substrate. This substrate may be, for example, a rigid or flexible facing sheet made of foil or another material, including another layer of similar or dissimilar polyurethane which is being conveyed, continuously or discontinuously, along a production line, or directly onto a conveyor belt.

In alternative embodiments the reacting mixture may be poured into an open mold or distributed via laydown equipment into an open mold or simply deposited at or into a location for which it is destined, i.e., a pour-in-place application, such as between the interior and exterior walls of a structure. In the case of deposition on a facing sheet, a second sheet may be applied on top of the deposited mixture. In other embodiments, the mixture may be injected into a closed mold, with or without vacuum assistance for cavity-filling. If a mold is employed, it is most typically heated.

The mixture, on reacting, takes the shape of the mold or adheres to the substrate to produce a polyurethane polymer of a more-or-less predefined structure, which is then allowed to cure in place or in the mold, either partially or fully. Suitable conditions for promoting the curing of the polymer include a temperature of typically from 20° C. to 150° C., preferably from 35° C. to 75° C., and more preferably from 45° C. to 55° C. Such temperatures will usually permit the sufficiently cured polymer to be removed from the mold, where such is used, typically within from 1 to 10 minutes and more typically within from 1 to 5 minutes after mixing of the reactants. Optimum cure conditions will depend upon the particular components, including catalysts and quantities used in preparing the polymer and also the size and shape of the article manufactured.

The result may be a rigid foam in the form of slabstock, a molding, a filled cavity, including but not limited to a pipe or insulated wall or hull structure, a sprayed foam, a frothed foam, or a continuously- or discontinuously-manufactured laminate product, including but not limited to a laminate or laminated product formed with other materials, such as hardboard, plasterboard, plastics, paper, metal, or a combination thereof. Advantageously, the polyurethane foams prepared in the present invention may show improved processability when compared with foams from formulations and preparation methods that are similar except that the formulations do not comprise the specific isocyanate reacting mixture used in the present invention. As used herein, the term “improved processability” refers to the capability of the foam to exhibit reduced defects, which may include but are not limited to shrinkage and deformation. This improvement may be particularly advantageous when the invention is used in the manufacture of sandwich panels. It is preferable that such reduced levels of shrinkage and deformation be less than 1.0% as linear deformation, as tested according to European Standard EN 1603 at 80° C., with specimen dimensions recorded after 20 hours. Sandwich panels may be defined, in some embodiments, as comprising at least one relatively planar layer (i.e., a layer having two relatively large dimensions and one relatively small dimension) of the rigid foam, faced on each of its larger dimensioned sides with at least one layer, per such side, of flexible or rigid material, such as a foil or a thicker layer of a metal or other structure-providing material. Such a layer may, in certain embodiments, serve as the substrate during formation of the foam.

The following examples illustrate the invention without limiting it.

### EXAMPLES

The materials below listed are used in the following examples:

“DABCO™ K-2097” is a solution of potassium-acetate in diethylene glycol, a catalyst available from Air Products;

“DMCHA” is N,N-dimethylcyclohexylamine, a catalyst available from Air Products;

“Glycerine” is glycerol propane 1,2,3 triol having a MW 92 and OH number=1806;

“IP-9001” is a polyester polyol from terephtalic acid, diethylene glycol and polyethylene glycol; functionality=2, OH number=220, available from Dow;

“IP-9004” is a polyester polyol from terephtalic acid, diethylene glycol, polyethylene glycol and glycerine; functionality=2.68, OH number=270, available from Dow;

“NIAX™ L6900” is a non-hydrolysable silicone polymer available from Momentive Performance Materials Inc.

“TCPP” is tris-(chloroisopropyl)phosphate, a flame retardant available from ICL-IP Bitterfeld Gmbh;

“TERATE™ 2540” is a polyester polyol, OH number=250, available from Invista;

“TERCAROL™ RF 33” is sucrose propoxylated polyether polyol with a hydroxyl value of 495 mg KOH/g, containing 12-17% (weight/weight) of polyether diol fraction, available from The Dow Chemical Company;

“TERCAROL™ RF 55” is a sorbitol propoxylated polyether polyol with a hydroxyl value of 495 mg KOH/g, containing 10-14% (w/w) of polyether diol fraction, available from The Dow Chemical Company;

“TERCAROL™ RM 601” is a sorbitol propoxylated polyether polyol with a hydroxyl value of 395 mg KOH/g, containing 16-20% (w/w) of polyether diol fraction, available from The Dow Chemical Company;

“VORANATE™ M-600” is a polymeric MDI; NCO=30.5%; viscosity=0.6 Pa·s at 25° C., available from The Dow Chemical Company.

“VORANOL™ P-400” is a polypropylene glycol, with a hydroxyl value of 280 mg KOH/g, available from The Dow Chemical Company;

“VORANOL™ RH 360” is a reaction mass of sucrose propoxylated and glycerine propoxylated, with a hydroxyl value of 360 mg KOH/g, available from The Dow Chemical Company;

“VORANOL™ RN 482” is a sorbitol propoxylated polyether polyol with a hydroxyl value of 480 mg KOH/g, available from The Dow Chemical Company;

“VORANOL™ RN 490” is a reaction mass of sucrose propoxylated and glycerine propoxylated, with a hydroxyl value of 490 mg KOH/g, available from The Dow Chemical Company; “VORANOL™ 1010L” is a polypropylene glycol, with a hydroxyl value of 110 mg KOH/g, available from The Dow Chemical Company.

All amounts are expressed as pbw, unless otherwise specified.

### Examples 1-5 and Comparative Examples

The formulations 1-5 of the present invention and the comparative formulations 1-5, illustrated in the following table, were prepared by hand-mixing the ingredients according to the following procedure: formulated polyol ingredients were poured into a plastic cup and homogeneously mixed at 2500 r.p.m. at controlled temperature (20° C.), adding n-pentane as last component. The resulting fully formulated polyol blend was then reacted with polymeric MDI by mixing the whole liquid mass at 2500 r.p.m. at 20° C. Before rise start, reacting foam was poured inside a wooden box (20×20×20 cm). After 20 minutes, produced foams were removed and free rise density was determined (obtaining values of 30-32 kg/m³). Compressive strength was then measured on 5×5×5 cm specimens, compressing them according to parallel and perpendicular direction versus foam rise direction. The formulations and foam properties are illustrated in the following table.

| | | | | | | Comp. | Comp. | Comp. | Comp. | Comp. |
|---|---|---|---|---|---|---|---|---|---|---|
| | Ex. 1 | Ex. 2 | Ex. 3 | Ex. 4 | Ex. 5 | Ex. 1 | Ex. 2 | Ex. 3 | Ex. 4 | Ex. 5 |
| Tercarol RF-55 | 28.7 | 26.7 | | 26.7 | 10 | 28.7 | 28.7 | 26.7 | | |
| Tercarol 601 | 28 | 26 | 28 | 25 | | 28 | 28 | 25 | | |
| Tercarol RF-33 | | | 28.7 | | | | | | | |
| Voranol RN-482 | | | | 5 | 35 | | | 5 | | |
| IP-9004 | 13 | 13 | 13 | 13 | 25 | | | | 13 | |
| Voranol RN-490 | | | | | | | | | 29 | 29 |
| Voranol RH-360 | | | | | | | | | 26.4 | 26.4 |
| IP-9001 | | | | | | 13 | | 13 | | 13.0 |
| Terate 2540 | | | | | | | 13 | | | |
| Voranol 1010L | 9 | | 9 | 9 | 8.7 | 9 | 9 | 9 | 11 | 11 |
| Voranol P-400 | | 13 | | | | | | | | |
| Glycerine | 2.3 | 2.3 | 2.3 | 2.3 | 2.3 | 2.3 | 2.3 | 2.3 | 2.3 | 2.3 |
| TCPP | 14.7 | 14.7 | 14.7 | 14.7 | 14.7 | 14.7 | 14.7 | 14.7 | 14 | 14 |
| Dabco K-2097 | 1 | 1 | 1 | 1 | 1 | 1 | 1 | 1 | 1 | 1 |
| Niax L-6900 | 1.2 | 1.2 | 1.2 | 1.2 | 1.2 | 1.2 | 1.2 | 1.2 | 1.2 | 1.2 |
| water | 2.1 | 2.1 | 2.1 | 2.1 | 2.1 | 2.1 | 2.1 | 2.1 | 2.1 | 2.1 |
| Fully formulated | 100 | 100 | 100 | 100 | 100 | 100 | 100 | 100 | 100 | 100 |
| polyol blend | | | | | | | | | | |
| DMCHA | 2.5 | 2.5 | 2.5 | 2.5 | 2.5 | 2.3 | 2.4 | 2.3 | 2.6 | 2.3 |
| n-Pentane | 9.5 | 9.5 | 9.5 | 9.5 | 9.5 | 9.5 | 9.5 | 9.5 | 9.5 | 9.5 |
| Voranate M-600 | 145 | 145 | 145 | 145 | 145 | 142 | 144 | 142 | 147 | 141 |
| FOAM TEST | | | | | | | | | | |
| Gel time (sec) | 48 | 47 | 48 | 46 | 50 | 47 | 49 | 45 | 45 | 45 |
| Free rise density (g/l) | 30.6 | 31.3 | 30.9 | 30.5 | 31.5 | 31.2 | 31.6 | 31.0 | 30.0 | 30.2 |
| Compressive strength | 232 | 240 | 244 | 257 | 251 | 206 | 198 | 221 | 240 | 239 |
| (kPa), parallel to rise | | | | | | | | | | |
| Compressive strength | 107 | 118 | 112 | 124 | 119 | 100 | 95 | 100 | 95 | 90 |
| (kPa), perpendicular | | | | | | | | | | |
| to rise | | | | | | | | | | |
| Average compressive | 169.5 | 179 | 178 | 190.5 | 185 | 153 | 146.5 | 160.5 | 162.5 | 164.5 |
| strength (kPa) | | | | | | | | | | |
| Max linear variation | <1 | <1 | <1 | <1 | <1 | n.d. | n.d. | n.d. | n.d. | n.d. |
| (%), after 20 h at 80° C. | | | | | | | | | | |
| Emulsion stability | 2.5 | 2.5 | | | | 1.0 | 0.33 | | | |
| (day) | | | | | | | | | | |

The results illustrated in table above show that the compressive strength of the foam formulations of the present invention show a remarkable improvement in comparison with the values obtained for the comparative examples. In particular, calculated average compressive strength values are higher in Examples 1-5 than in the Comparative Examples 1-5.

Besides, n-pentane compatibility was evaluated for the formulations of the Examples 1-2 and Comparative Examples 1-2, by measuring the emulsion stability, which is an index of the blowing agent compatibility in the polyol blend. Fully formulated blends (prepared according to previously reported methodology), containing DMCHA and n-pentane were poured into 250 ml transparent glass bottle. Emulsion stability time was recorded. The results, illustrated in the last row of the above table, show that n-pentane emulsification is more stable in time for the formulations of the present invention than for the ones of the comparative examples.

1. A polyurethane foam formulation comprising:
(A) an isocyanate reacting mixture comprising:
(i) 10-40% by weight of at least one aromatic polyester polyol having a hydroxyl number of at least 50 mg KOH/g and a functionality greater than 2;
(ii) 30-75% by weight of at least one propoxylated sucrose- and/or propoxylated sorbitol-initiated polyol, having a molecular weight of 200-1,500, a hydroxyl number of at least 150 mg KOH/g and a functionality of at least 4;
(iii) 5-25% by weight of at least one polyether polyol based on propylene glycol moiety, having a hydroxyl value of 50-600 mg KOH/g;
all percentages in (i), (ii) and (iii) being based on the overall weight of the isocyanate reacting mixture;
(B) at least one polymeric diphenylmethane diisocyanate having a functionality of at least 2.7; and
(C) at least one blowing agent;
such that the stoichiometric index of the polyisocyanate to the isocyanate reacting mixture is 1.0-1.8.

2. The polyurethane foam formulation according to claim 1, wherein the aromatic polyester polyol is selected from aromatic polyester polyols having an acid component comprising at least 30% by weight of phthalic acid residues, or residues of isomers thereof.

3. The polyurethane foam formulation according to claim 2, wherein the aromatic polyester polyol has an aromatic ring content of at least 50% by weight, based on the aromatic polyester polyol weight.

4. The polyurethane foam formulation according to claim 3, wherein the aromatic polyester polyol is obtained by the transesterification of crude reaction residues or scrap polyester resins.

5. The polyurethane foam formulation according to claim 3, wherein the aromatic polyester polyol has a hydroxyl number of 50-400 mg KOH/g.

6. The polyurethane foam formulation according to claim 5, wherein the aromatic polyester polyol has a hydroxyl number of 150-300 mg KOH/g.

7. The polyurethane foam formulation according to claim 5, wherein the aromatic polyester polyol has a functionality higher than 2 up to 8.

8. The polyurethane foam formulation according to claim 1, wherein the propoxylated sucrose- and/or propoxylated sorbitol-initiated polyol have a molecular weight of 450-900, a functionality of 4-8 and a hydroxyl number of 300-550 mg KOH/g.

9. The polyurethane foam formulation according to claim 8, wherein the propoxylated sucrose- and/or propoxylated sorbitol-initiated polyol are water co-initiated.

10. The polyurethane foam formulation according to claim 8, wherein the propoxylated sucrose- and/or propoxylated sorbitol-initiated polyol are contained in a water co-initiated sorbitol and/or sucrose based polyols.

11. The polyurethane foam formulation according to claim 1, wherein the polyether polyol is in an amount 8-20% by weight with respect to the overall weight of the isocyanate reacting mixture and has a hydroxyl value of 100-300 mg KOH/g.

12. (canceled)

13. The polyurethane foam formulation according to claim 1, wherein the blowing agent is selected from the group consisting of at least one among butane, isobutane, 2,3-dimethylbutane, n- and i-pentane isomers, hexane isomers, heptane isomers, cycloalkanes including cyclopentane, cyclohexane, cycloheptane, HFC-245fa (1,1,1,3,3-pentafluoropropane), HFC-365 mfc (1,1,1,3,3-penta-fluorobutane), HFC-227ea (1,1,1,2,3,3,3-heptafluoropropane), HFC-134a (1,1,1,2-tetrafluoroethane), formic acid, isobutyric acid, ethylbutyric acid, ethylhexanoic acid, water and carbamates.

14. The polyurethane foam formulation according to claim 1, wherein the polymeric diphenylmethane diisocyanate has a functionality of 2.7-2.9.

15. (canceled)

16. The polyurethane foam formulation according to claim 1, comprising water, at least one surfactant, at least one crosslinker, at least one catalyst and at least one flame retardant.

17. The polyurethane foam formulation according to the claim 16, wherein water, the surfactant, crosslinker, catalyst and flame retardant are in an overall amount of 6-12 pbw and wherein (A), (B) and (C) are in an amount of 25-35 pbw, 50-65 pbw, 2-5 pbw, respectively.

18. An isocyanate reacting mixture comprising:
(i) 10-40% by weight of at least one aromatic polyester polyol having a hydroxyl number of at least 50 mg KOH/g and a functionality greater than 2;
(ii) 30-75% by weight of at least one propoxylated sucrose- and/or propoxylated sorbitol-initiated polyol, having a molecular weight of 200-1,500, a hydroxyl number of at least 150 mg KOH/g and a functionality of at least 4;
(iii) 5-25% by weight of at least one polyether polyol based on propylene glycol moiety, having a hydroxyl value of 50-600 mg KOH/g;
all percentages in (i), (ii) and (iii) being based on the overall weight of the isocyanate reacting mixture.

19. A process for preparing a polyurethane foam comprising contacting, under foam-forming conditions, (A) an isocyanate reacting mixture comprising: (i) 10-40% by weight of at least one aromatic polyester polyol having a hydroxyl number of at least 50 mg KOH/g and a functionality greater than 2; (ii) 30-75% by weight of at least one propoxylated sucrose- and/or propoxylated sorbitol-initiated polyol, having a molecular weight of 200-1,500, a hydroxyl number of at least 150 mg KOH/g and a functionality of at least 4; (iii) 5-25% by weight of at least one polyether polyol based on propylene glycol moiety, having a hydroxyl value of 50-600 mg KOH/g; all percentages in (i), (ii) and (iii) being based on the overall weight of the isocyanate reacting mixture; (B) at least one polymeric diphenylmethane diisocyanate (PMDI) having a functionality of at least 2.7; and (C) at least one blowing agent; such that the stoichiometric index of the polyisocyanate to the isocyanate reacting mixture is 1.0-1.8; to form a polyurethane rigid foam.

20. The process for preparing a polyurethane foam according to claim 1, wherein the isocyanate reacting mixture, polyisocyanate and blowing agent are contacted as two streams, three streams, or more than three streams, wherein the streams are sprayed or deposited onto a substrate.

21. (canceled)

22. The process for preparing a polyurethane foam according to claim 20, wherein the substrate is selected from the group consisting of a rigid or flexible facing sheet made of foil or another material, including another layer of similar or dissimilar polyurethane which is being conveyed, continuously or discontinuously, along a production line, or directly onto a conveyor belt.

23. The process for preparing a polyurethane foam according to claim 22, wherein a sandwich panel is formed.

24. (canceled)

25. (canceled)
